(19) United States
(12) Patent Application Publication
(10) Pub. No.: US 2012/0013617 A1
(43) Pub. Date: Jan. 19, 2012

(54) METHOD FOR GLOBAL PARAMETERIZATION AND QUAD MESHING ON POINT CLOUD

(75) Inventors: Xiaopeng Zhang, Beijing (CN); Er Li, Beijing (CN); Wujun Che, Beijing (CN); Weiming Dong, Beijing (CN)

(73) Assignee: Institute of Automation, Chinese Academy of Sciences, Beijing (CN)

(21) Appl. No.: 13/001,906

(22) PCT Filed: Dec. 30, 2009
(86) PCT No.: PCT/CN2009/001591

§ 371 Date: Dec. 29, 2010

(51) Int. Cl. G06T 17/20

(52) U.S. Cl. 345/420

(57) ABSTRACT

The present invention comprises a method for global parameterization and quadrangulation on point cloud. The method comprises: (a) computing and smoothing principal direction field over the point cloud; (b) performing a global parameterization of the point cloud; (c) constructing a quad mesh from the resultant parameterization. The present method is fully automatic, and can be used to all point models with any genus values. This approach can be used to many applications, such as texture mapping, surface fitting and shape analysis.

### FIELD OF THE INVENTION

The present invention generally relates to point cloud data obtained by laser scan device in the area of computer graphics and computer vision, especially relates to methods of global parameterization and quad meshing on point cloud.

### BACKGROUND OF THE INVENTION

Point cloud has been widely used in CAD and computer graphics communities due to the development of fast and accurate laser scan devices. Usually, there is no topological information in the raw scan points, and an amount of research work focus on meshing the point cloud while exhibiting the original surface well. Although most of the previous work produce high quality triangle meshes, there is little consideration about how to control the shape and orientation of triangles. A quad dominant mesh is preferred rather than a triangle mesh in many applications due to their tensor-product nature, such as in texturing, simulation with finite elements and B-spline fitting. And the quad mesh following principle directions is particularly useful in modeling as they capture the symmetries of natural geometry.

Global parameterization is a useful tool to design quadrangulation. Ray et al. propose periodic global parameterization guided by principle directions to parameterize the input model (Ray, N., Li, W. C., Levy, B., Sheffer, A., Alliez, P. 2006; Periodic global parameterization; ACM Trans. Graph. 25, 4, 1460-1485). Thus a quadrilateral mesh can be got by tracking the iso-lines in the parameterize domain. This method can generate a high quality quad mesh without any user's interaction. However, this method is limited to a triangle mesh; for a point cloud without connection information, it is difficult to use the method in the art directly to processing point cloud data.

### SUMMARY OF THE INVENTION

The subject of the invention is to provide a method of global parameterization and quad meshing on a point cloud, comprising:

1) Calculating and smoothing principal direction field;

2) Performing Global parameterization of point cloud;

3) Constructing a Quad mesh from the resultant parameterization.

The present invention provides a robust and automatic global parameterization for unorganized point cloud data obtained from laser scan devices, and then extracting a feature-aligned quad mesh from the resultant parameterization.

### BRIEF DESCRIPTION OF THE DRAWINGS

FIG. 1 is a schematic diagram of the whole algorithm.

FIG. 2 is a flow chart of the calculation of principal directions.

FIG. 3 is a flow chart of the global parameterization.

FIG. 4 is a flow chart of the quadrangulation.

FIG. 5 illustrates the processing of the iso-segments.

FIG. 6 is an example of quadrangulation on point data rock-arm.

FIG. 7 is an example of quadrangulation on noisy point data chair.

### DETAILED DESCRIPTION OF THE INVENTION

Embodiments of the invention are explained in greater detail by way of the drawings. However the description itself is not intended to limit the scope of the invention.

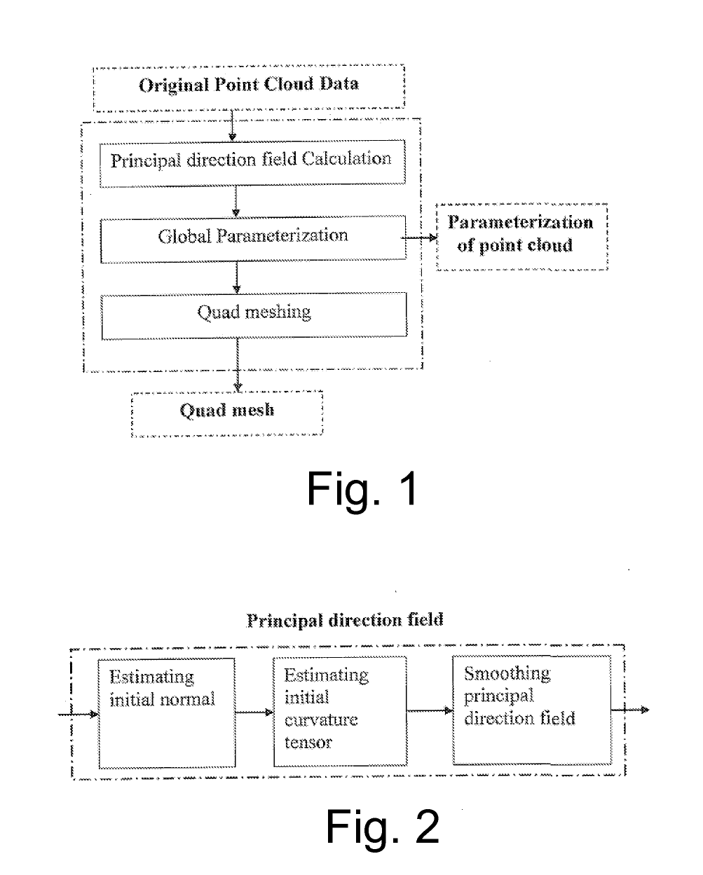

As illustrated in FIG. 1, the present method comprises three steps: the calculation of principal direction; performing global parameterization of point cloud; constructing a quad mesh from the resultant parameterization. Detailed description of each step is as follows.

As illustrated in FIG. 2, the calculation of principal direction requires the normal at each point since there is only coordinate information in the 3D point cloud data. It is necessary to compute the normal vector for each point before calculating the principal direction and performing local Delaunay triangulation. First, a kd tree is constructed. In computing geometry, the kd tree has proven to be one of most efficient data structure for nearest neighbor query. Based on the point positions in 3D space, the kd tree divides the 3D space into two parts iteratively to achieve optimized data structure. The time complexity of k nearest neighbor query in a kd tree is O (log2n), where n is the number of points in the point cloud.

For estimating the normal of a point, 15 or 30 neighboring points are selected; if these points are almost in the same plane, the tangent plane at this point can be obtained by fitting a weighted sum of the distances of the neighboring points to the fitting plane. The weight for each neighboring point is defined as the reciprocal of the Euclidean distance to this point. A plane is obtained by least square fitting and then the normal vector of this plane is defined as the normal at this point.

A smooth and accurate principal direction field is necessary since the global parameterization is constrained by the principal direction field. The construction of a principal direction field comprises two steps as in the last two steps of FIG. 2: estimation of curvature tensor and a global smoothing.

To calculate the curvature tensor, local coordinates are first constructed for each point. Let \vec{N} denote the normal vector of point p, then p is the original point of the local coordinates. Let \vec{u}, \vec{v}, \vec{w} represent the three directions of local coordinates, \vec{N}ᵢ is the normal of p's neighboring point pᵢ , then the curvature tensor at p satisfy the following constraints:

$$[ \begin{matrix}{∇}_{\vec{u}} \vec{N} \cdot \vec{u} & {∇}_{\vec{v}} \vec{N} \cdot \vec{u} & \vec{N} \cdot \vec{u} \\ {∇}_{\vec{u}} \vec{N} \cdot \vec{v} & {∇}_{\vec{v}} \vec{N} \cdot \vec{v} & \vec{N} \cdot \vec{v} \\ {∇}_{\vec{u}} \vec{N} \cdot \vec{w} & {∇}_{\vec{v}} \vec{N} \cdot \vec{w} & \vec{N} \cdot \vec{w}\end{matrix} ] \cdot [ \begin{matrix}{∇}_{\vec{p}} \cdot \vec{u} \\ {∇}_{\vec{p}} \cdot \vec{v} \\ 1\end{matrix} ] = [ \begin{matrix}\vec{{N}_{i}} \cdot \vec{u} \\ \vec{{N}_{i}} \cdot \vec{v} \\ \vec{{N}_{i}} \cdot \vec{w}\end{matrix} ]$$

15 neighboring points are chosen to provide a set of linear constraints on the elements of the curvature tensor, which may be determined using least squares, and then the principal directions at p are calculated.

Local triangulation is to construct topological connections in a small area of each point p in the point cloud. For each point p of point cloud, the 15 neighboring points are projected to the tangent plane and then a local Delaunay triangulation is performed in the tangent plane. A local triangulation near point p is derived from this 2D local Delaunay triangulation in the tangent plane by keeping topological connections. The edges and triangulations used in the following sections are based on this local Delaunay triangulation.

The global smoothing of principal direction field makes the principal direction more consistent. The present invention defines an energy function to measure the difference between the principal directions of neighboring points, and then the principal direction is smoothed through minimizing this energy function.

The energy function is defined as follows:

$$E ( {α}_{i} ) = ( 1 - ρ ) {\sum }_{i} {sin}^{2} ( {α}_{i} - {α}_{i}^{0} ) - {E}_{smoothing}$$

$$where$$

$${E}_{smoothing} = ρ {\sum }_{i , j} {cos}^{2} ( ( {α}_{i} - {β}_{ij} ) - ( {α}_{j} - {β}_{ij} ) )$$

here αᵢ are the unknown angles between the principle directions and a reference direction in the tangent plane, and βᵢⱼ represents the angle between the projection of edge i, j into the tangent plane and the reference direction. The user-defined parameter ρ indicates the smooth intensity. The function can be solved as an optimization problem using Newton's method, and then a smooth direction field is achieved.

The goal of global parameterization is to find two scalar functions θ and φ, whose gradients align with the principal directions as much as possible. Global parameterization comprises three steps as illustrated in

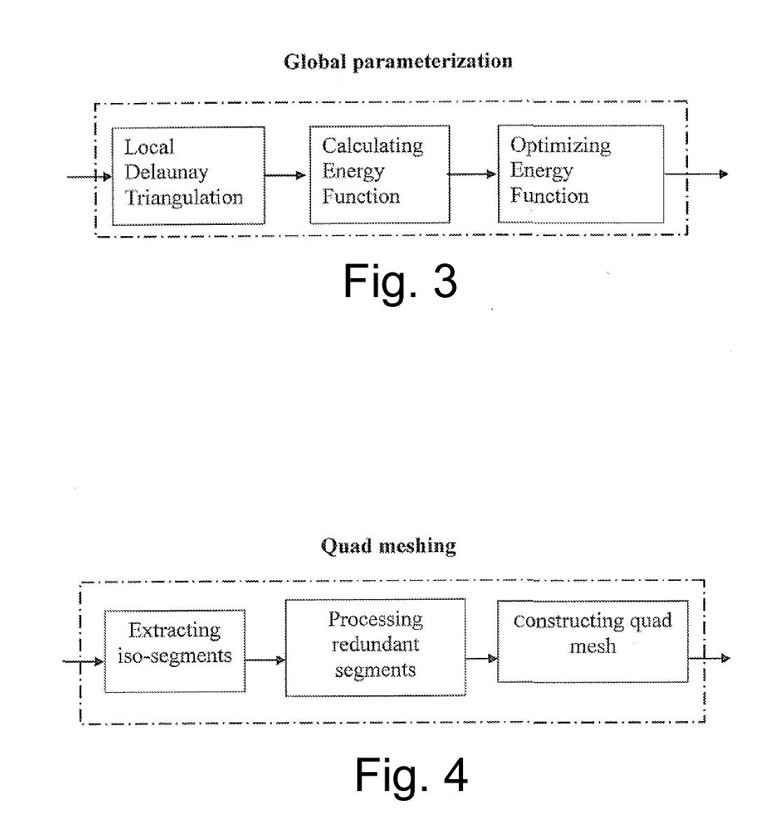

FIG. 3: local Delaunay triangulation, calculating energy function, optimizing energy function. Local triangulation is defined as the same as in the smoothing of principal direction field. The energy function that measures the difference between the gradients and principal direction field is defined as follows:

F=∫_{S}(∥∇θ^{T}−ω\vec{K}∥²+∥∇φ^{T}−ω\vec{K}^{⊥}∥²)dS

The gradient of a scalar function at a point is defined as the sum of the gradients of its adjacent triangles, and the gradient in each triangle is defined as the sum of the gradient of each edge. In practice, the above equation is calculated as:

$$F = {\sum }_{i , j} {( {θ}_{i} - {θ}_{j} - wK \cdot {e}_{ij} )}^{2} + {\sum }_{i , j} {( {ϕ}_{i} - {ϕ}_{j} - {wK}^{⊥} \cdot {e}_{ij} )}^{2}$$

here, θᵢ and φᵢ denote the two scalar functions at point i, and K and K^{⊥} denote the principal directions, eᵢⱼ denote the vector between and w is a user-defined parameter to control the density of parameterization.

The function can be solved as a quadratic optimization problem using Newton's method, and then a global parameterization of the point cloud is achieved.

Since the iso-lines of the resultant parameterization align the principal directions, the curve nets of iso-lines are a good start for quadrangulation. The intersection points of iso-lines are the vertices of final quad mesh, and the connection relationship among these vertices are determined by their connection relationship in the iso-lines.

To remesh the point cloud, as illustrated in FIG. 4, the iso-segments in each triangle are first extracted, then the redundant segments are processed according to some rules and finally a quad mesh is constructed.

Here the iso-lines comprise iso-segments in each triangle. Let the scalar value of the three points of a triangle is θᵢ, θⱼ, and θₖ, and the iso-value is θᵢₛₒ, for each edge eᵢⱼ of the triangle, if min (θᵢ, θⱼ)<θᵢₛₒ<max ( θᵢ, θⱼ), the intersection vertex of iso-line and this edge is

$$p = {p}_{i} + \frac{\vert {θ}_{i} - {θ}_{iso} \vert}{\vert {θ}_{i} - {θ}_{j} \vert} \cdot ( {p}_{j} - {p}_{i} ) .$$

Here, pᵢ, pⱼ are the end points of eᵢⱼ. For each triangle, if min (θᵢ, θⱼ, θₖ)<θᵢₛₒ<max (θᵢ, θⱼ, θₖ), two intersection points are produced, the iso-segments are obtained by connecting these two points. For a triangle, if the iso-segments corresponding to θ and φ exist simultaneously, then the intersection vertex of these two iso-segments is calculated, which is the intersection of iso-lines.

Redundant triangles exist due to the overlapping triangles produced by local Delaunay triangulation. To handle the irregular points in the iso-lines, three rules are adopted to clean the iso-lines:

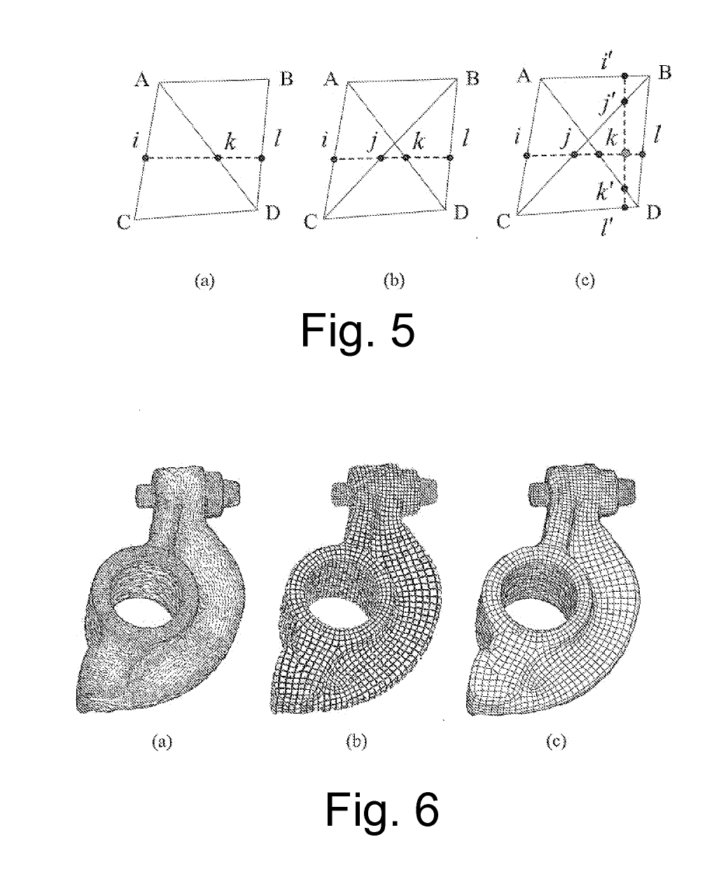

1. In the first case, a triangle does not overlay any adjacent triangles as shown in FIG. 5(a), then calculate the iso-segments with end points i, k and l. If the segments in the adjacent triangle have the same end point k , then they can be merged as i, k, l.

2. In the second case, a triangle overlays one of its adjacent triangles as shown in FIG. 5(b), then for the iso-segments with common vertex in this overlapping triangle, only the longer iso-segment is kept while the shorter is abandoned; i.e. point j is deleted and the index pair of i and k and the pair of k and l are merged as i, j.

3. In the third case, a triangle overlaps its one adjacent triangle and two intersection points of iso-segments appear in both of them as shown in FIG. 5(c), the two intersection points are merged by their average point.

After the processing of iso-lines, each intersection point in the iso-lines is connected with its neighboring intersection points according to the iso-segment connections, and thus a quad mesh is constructed.

The algorithm described in this invention is implemented in C++ programming language and tested on several models on a PC with Intel® Core™2 Quad CPU Q6600 and 4GB memory. OpenGL is used for the visualization. Table 1 gives the size of some models (number of points) and the time cost of the main steps (Curvature Estimation, Local triangulation, Global Parameterization) of our algorithm.

| | | Curvature | Local | Global |
|---|---|---|---|---|
| | Point | Estimation | Triangulation | Parameterization |
| Model | Number | (Sec) | (Sec) | (Sec) |
| Saddle | 4860 | 1.89 | 1.72 | 8.28 |
| Rock-arm | 14413 | 4.48 | 4.56 | 11.23 |
| Cup | 57826 | 15.14 | 12.67 | 42.36 |
| Soldier | 68740 | 20.78 | 15.84 | 47.03 |
| Chair | 209499 | 60.77 | 47.13 | 156 |

FIG. 6 gives the result on a noise model, in which 1% Gaussian noise is added. FIG. 6(a) shows the smoothed principal direction field; FIG. 6(b) shows the two iso-lines in blue and red, FIG. 6(c) is the quad mesh. The resultant quads distribute across the surface evenly and capture the geometry feature. The results are obtained from point cloud, and for better visualization they are rendered on triangle surfaces.

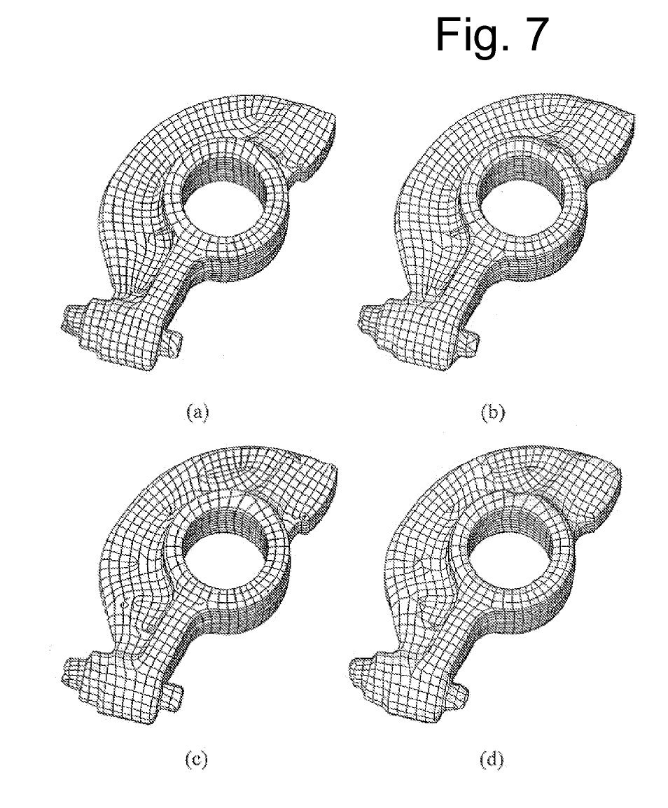

In FIG. 7, we apply our algorithm directly to the point cloud of the rock-arm model, and compare with the results produced by periodic global parameterization method (PGP) on a triangular mesh [Ray et al. 2006]. FIG. 7(a) and FIG. 7(b) are our iso-lines and quad mesh, and FIG. 7(c) and FIG. 7(d) are Ray's results. We can see that although our method uses only the position information without connectivity information, our approach has no less quality than that of PGP.

The innovation of this invention is a direct quad meshing method on point cloud without a mesh reconstruction step. And this method is fully automatic; the density of quad mesh can be controlled easily by adjusting the parameter.

The present invention can be applied to point cloud data for both global parameterization and quad meshing. The present invention may be used in other computer graphics applications and is of high practical value.

Although the present invention has been specifically described on the basis of a preferred embodiment and a preferred method, the invention is not to be construed as being limited thereto. Various changes or modifications may be made to said embodiment and method without departing from the scope and spirit of the invention.

What is claimed is:

1. A method for global parameterization and quadrangulation on point cloud, comprising:
(a) calculating and smoothing principal direction field;
(b) performing global parameterization of point cloud;
(c) constructing a quad mesh from the resultant parameterization.

2. The method according to claim 1, wherein said calculating principal direction field comprises: calculating the initial normal for each point; and
calculating the curvature tensor for each point.

3. The method according to claim 1, wherein said performing global parameterization comprises:
performing local Delaunay triangulation for each point;
determining the energy function for each point;
obtaining the optimized solution for an energy function.

4. The method according to claim 1, wherein said constructing a quad mesh comprises: extracting iso-segments for each triangle; processing the redundant segments; and constructing the quad mesh.

5. The method according to claim 2, wherein the curvature tensor of a point is obtained by fitting the initial normal vectors of its neighboring points in order to calculate the principal direction of each point.

6. The method according to claim 3, wherein for each point,
selecting 15 or 30 nearest points and projecting these points onto the tangent plane of the underlying point;
performing a Delaunay triangulation of these projected points in the tangent plane.

7. The method according to claim 6, wherein said local Delaunay triangulation comprises: for each point
15 nearest points are projected onto the tangent plane and then a 2D triangulation is performed in the tangent plane that maximizes the minimal inner angles of the resultant triangles;
for each triangle in the resultant triangulation, the 3D points, corresponding to vertices of this triangle, are connected.

8. The method according to claim 1, wherein said smoothing principal direction field comprises:
determining the difference between a principal direction on each point and principal directions on neighboring points;
updating the principal directions by minimizing the sum of those differences.

9. The method according to claim 2, wherein said the gradient of scalar functions defined on point cloud is determined by utilizing the connection information of local triangulations.

10. The method according to claim 9, wherein said the gradient of the scalar functions defined on point cloud comprises:
calculating the gradient of the scalar functions over the adjacent triangles for a point;
obtaining the gradient of the scalar functions at this point as the sum of gradient on its adjacent triangles.

11. The method according to claim 10, wherein the optimization of alignment between gradient of the scalar functions and principal direction comprises: setting two scalar functions of θ and φ on point p, the energy function measuring the difference between gradient of the scalar functions and principal directions is defined as follows:
F=∫_{S}(∥∇θ^{T}−ω\vec{K}∥²+∥∇φ^{T}−ω\vec{K}^{⊥}∥²)dS
where ω is a user defined parameter that controls the distribution of parameterization, \vec{K} is the maximal principal direction, and \vec{K}^{⊥} is the minimal principal direction; θ and φ are solved by minimizing F.

12. The method according to claim 11, wherein the energy function
F=∫_{S}(∥∇θ^{T}−ω\vec{K}∥²+∥∇φ^{T}−ω\vec{K}^{⊥}∥²)dS
is discretized as
F=Σ(θᵢ−θⱼ−wK·eᵢⱼ)²+Σ(φᵢ−φⱼ−wK^{⊥}·eᵢⱼ)²
where θᵢ, φᵢ denote the two scalar functions at point i, \vec{K} and \vec{K}^{⊥} is the minimal and maximal principal directions, eᵢⱼ is the vector from point i to point j, ω is a user defined parameter that controls the distribution of parameterization.

12. The method according to claim 4, wherein said extracting iso-segments for each triangle comprises:
determining the maximal and minimal scalar functions in this triangle; determining the iso-values in the interval defined by maximal and minimal values;
obtaining the iso-segments according to the linear interpolation.

13. The method according to claim 4, wherein the intersection points of iso-segments are determined by intersecting the iso-segments extracted in each triangle: for each triangle if there are two iso-segments responding to θ and φ respectively, then the intersection point of these two iso-segments is defined as one vertex of the final quad mesh.

14. The method according to claim 4, wherein said processing the redundant segments comprises:
if a triangle does not overlay any adjacent triangles, its iso-segments are calculated and the intersection points are obtained, and the iso-segments with the same endpoints are merged for those segments in its adjacent triangles; if a triangle overlaps its one adjacent triangle, then for the iso-segments with common vertex in this overlapping triangle, only the longer iso-segment is kept while the shorter is abandoned;
if a triangle overlaps its one adjacent triangle and two intersection points of iso-segments appear in both of them, the two intersection points are merged by their average point.
